(19) United States
(12) Patent Application Publication
(10) Pub. No.: US 2021/0270629 A1
(43) Pub. Date: Sep. 2, 2021

(54) METHOD AND APPARATUS FOR SELECTING A PATH TO A DESTINATION

(71) Applicant: HERE Global B.V., Eindhoven (NL)

(72) Inventors: Nikhil Vinay SHARMA, Jaipur (IN); Siddarth SREENI, Kochi (IN)

(73) Assignee: HERE Global B.V., Eindhoven (NL)

(21) Appl. No.: 16/803,302

(22) Filed: Feb. 27, 2020

(51) Int. Cl. G01C 21/36

(52) U.S. Cl. CPC G01C 21/3644; G01C 21/3629; G01C 21/3608

(57) ABSTRACT

A method, apparatus and computer program product are provided for selecting a path to a destination. In the context of a method, first vectors are defined that are representative of a plurality of respective candidate paths from an origin to the destination. Each first vector is at least partially defined by directional information associated with one or more segments of the respective candidate path. The method also includes defining a second vector representative of a textual description of a specified path from the origin to the destination. The second vector is at least partially defined by directional information associated with one or more segments of the specified path. The method further includes identifying a particular vector, from among the first vectors, based on a similarity of the particular vector to the second vector and selecting a particular candidate path that is represented by the particular vector that is identified.

### TECHNOLOGICAL FIELD

An example embodiment relates generally to a method and apparatus for defining a route, such as may be provided by a navigation system, and, more particularly, to selecting a path to a destination from among a plurality of candidate paths with the path defining at least a portion of the route.

### BACKGROUND

Navigation systems define routes from various origins to respective destinations. These routes are useful for promoting efficient travel to the respective destinations, for accurately estimating the time of arrival at the respective destinations and for many other navigational purposes. In some situations, however, certain portions of a route may be difficult to define. In this regard, the last portion of a route leading to a destination, sometimes referred to as the last mile, may sometimes be difficult to define and, indeed, may not be able to be defined in such a manner as to actually reach the intended destination. For example, the destination may be a location within a complex of buildings through which a network of roads is not well defined. In this instance, the navigation system may define a route to a location in the vicinity of the intended destination, but the location may not actually be the intended destination as a result of the lack of clarity of the network of roads through the complex of buildings.

In such instances, a person at the destination, such as the intended recipient of a package, the passenger of a rideshare vehicle or taxi services or the like, may provide directions to the destination. Alternatively, a driver or other person who previously traveled to the destination may provide directions to the destination in order to assist others in locating the destination. While these directions may be useful, the directions may vary widely, such as in terms of the level of detail, the names by which locations and other points of interest along the route are referenced and the like, depending upon the person providing the directions. Moreover, the usefulness of such directions is also dependent upon the accuracy with which the directions are recorded and/or transcribed and the ease and consistency with which the directions for the last portion of a route may be integrated with the more conventional directions provided by a navigation system. Consequently, navigation, particularly over the final portion of a route, such as the last mile, remains challenging in some instances.

### BRIEF SUMMARY

A method, apparatus and computer program product are provided in accordance with an example embodiment in order to select a path to a destination, thereby facilitating navigation to the destination in an efficient and accurate manner, including navigation over the final portion of the route to the destination. In an example embodiment, the path that is selected may be selected from a plurality of candidate paths with the selection being made such that the likelihood of the selected path providing for navigation to the destination is enhanced. As a result, the path that is selected may reduce some of the uncertainty that may otherwise be associated with directions provided by a person at the destination or a driver who previously visited the destination.

In an example embodiment, a method is provided for selecting a path to a destination. The method includes defining first vectors representative of a plurality of respective candidate paths from an origin to the destination. Each first vector is at least partially defined by directional information associated with one or more segments of the respective candidate path. The method also includes defining a second vector representative of a textual description of a specified path from the origin to the destination. The second vector is at least partially defined by directional information associated with one or more segments of the specified path. The method further includes identifying a particular vector, from among the first vectors, based on a similarity of the particular vector to the second vector and selecting a particular candidate path, from the plurality of candidate paths, that is represented by the particular vector identified based on the similarity of the particular vector to the second vector.

The method of an example embodiment also includes converting an audio description of the specified path to the textual description, such as in real time or near real time. In an example embodiment, the method defines the second vector based on one or more points of interest, one or more landmarks, one or more features of a map or one or more directions associated with the one or more segments of the specified path. The method of an example embodiment identifies the particular vector by identifying the particular vector to be the most similar of the first vectors in comparison to the second vector. In an instance in which a length of an extended segment of the one or more segments exceeds a threshold, the method defines the first vector that includes the extended segment that exceeds the threshold to include a plurality of elements that are each representative of the extended segment that exceeds the threshold. In an example embodiment, a respective first vector is defined that includes a plurality of elements representative of the directional information associated with the one or more segments of the respective candidate path. In this example embodiment, the plurality of elements uniquely represent each point of interest or each direction associated with the one or more segments of the respective candidate path. The method of an example embodiment also includes identifying a point of interest from the textual description, determining whether map data that includes the origin and the destination fails to represent the point of interest and, in an instance in which the map data fails to represent the point of interest, updating the map data to include the point of interest. In this example embodiment, the method may update the map data to include the point of interest by associating the point of interest with a location that is at least partially defined by the textual description from which the point of interest was identified. The location is represented by the map data in this example embodiment.

In another example embodiment, an apparatus is provided that is configured to select a path to a destination. The apparatus includes processing circuitry and at least one memory including computer program code instructions with the computer program code instructions configured to, when executed by the processing circuitry, cause the apparatus to define first vectors representative of a plurality of respective candidate paths from an origin to the destination. Each first vector is at least partially defined by directional information associated with one or more segments of the respective candidate path. The computer program code instructions are also configured to, when executed by the processing circuitry, cause the apparatus to define a second vector representative of a textual description of a specified path from the origin to the destination. The second vector is at least partially defined by directional information associated with one or more segments of the specified path. The computer program code instructions are further configured to, when executed by the processing circuitry, cause the apparatus to identify a particular vector, from among the first vectors, based on a similarity of the particular vector to the second vector and to select a particular candidate path, from the plurality of candidate paths, that is represented by the particular vector identified based on the similarity of the particular vector to the second vector.

The computer program code instructions are further configured to, when executed by the processing circuitry, cause the apparatus of an example embodiment to convert an audio description of the specified path to the textual description, such as in real time or near real time. The computer program code instructions are configured to, when executed by the processing circuitry, cause the apparatus of an example embodiment to define the second vector by defining the second vector based on one or more points of interest, one or more landmarks, one or more features of a map or one or more directions associated with the one or more segments of the specified path. The computer program code instructions are configured to, when executed by the processing circuitry, cause the apparatus of an example embodiment to identify the particular vector by identifying the particular vector to be the most similar of the first vectors in comparison to the second vector. In an instance in which a length of an extended segment of the one or more segments exceeds a threshold, the computer program code instructions are configured to, when executed by the processing circuitry, cause the apparatus of an example embodiment to define the first vector that includes the extended segment that exceeds the threshold to include a plurality of elements that are each representative of the extended segment that exceeds the threshold.

The computer program code instructions are configured to, when executed by the processing circuitry, cause the apparatus of an example embodiment to define a respective first vector to comprise a plurality of elements representative of the directional information associated with the one or more segments of the respective candidate path. In this example embodiment, the plurality of elements uniquely represent each point of interest or each direction associated with the one or more segments of the respective candidate path. The computer program code instructions are further configured to, when executed by the processing circuitry, cause the apparatus of an example embodiment to identify a point of interest from the textual description, determine whether map data that includes the origin and the destination fails to represent the point of interest and, in an instance in which the map data fails to represent the point of interest, update the map data to include the point of interest. In this example embodiment, the computer program code instructions may be further configured to, when executed by the processing circuitry, cause the apparatus to update the map data to include the point of interest by associating the point of interest with a location that is at least partially defined by the textual description from which the point of interest was identified. The location is represented by the map data in this example embodiment.

In a further example embodiment, a computer program product is provided that is configured to select a path to a destination. The computer program product includes at least one non-transitory computer-readable storage medium having computer-executable program code instructions stored therein with the computer-executable program code instructions including program code instructions configured, upon execution, to define first vectors representative of a plurality of respective candidate paths from an origin to the destination. Each first vector is at least partially defined by directional information associated with one or more segments of the respective candidate path. The computer-executable program code instructions also include program code instructions configured to define a second vector representative of a textual description of a specified path from the origin to the destination. The second vector is at least partially defined by directional information associated with one or more segments of the specified path. The computer-executable program code instructions further include program code instructions configured to identify a particular vector, from among the first vectors, based on a similarity of the particular vector to the second vector and program code instructions configured to select a particular candidate path, from the plurality of candidate paths, that is represented by the particular vector identified based on the similarity of the particular vector to the second vector.

The computer-executable program code instructions of an example embodiment also include program code instructions configured to convert an audio description of the specified path to the textual description, such as in real time or near real time. In an example embodiment, the program code instructions configured to define the second vector include program code instructions configured to define the second vector based on one or more points of interest, one or more landmarks, one or more features of a map or one or more directions associated with the one or more segments of the specified path. The program code instructions of an example embodiment are configured to identify the particular vector by identifying the particular vector to be the most similar of the first vectors in comparison to the second vector. In an example embodiment in which a length of an extended segment of the one or more segments exceeds a threshold, the program code instructions configured to define the first vector that includes the extended segment that exceeds the threshold define the first vector to include a plurality of elements that are each representative of the extended segment that exceeds the threshold. In an example embodiment, a respective first vector is defined that includes a plurality of elements representative of the directional information associated with the one or more segments of the respective candidate path. In this example embodiment, the plurality of elements uniquely represent each point of interest or each direction associated with the one or more segments of the respective candidate path. In an example embodiment, the program code instructions are further configured to identify a point of interest from the textual description, determine whether map data that includes the origin and the destination fails to represent the point of interest and, in an instance in which the map data fails to represent the point of interest, update the map data to include the point of interest. In this example embodiment, the program code instructions may be further configured to update the map data to include the point of interest by associating the point of interest with a location that is at least partially defined by the textual description from which the point of interest was identified. The location is represented by the map data in this example embodiment.

In yet another example embodiment, an apparatus is provided that is configured to select a path to a destination. The apparatus includes means for defining first vectors representative of a plurality of respective candidate paths from an origin to the destination. Each first vector is at least partially defined by directional information associated with one or more segments of the respective candidate path. The apparatus also includes means for defining a second vector representative of a textual description of a specified path from the origin to the destination. The second vector is at least partially defined by directional information associated with one or more segments of the specified path. The apparatus further includes means for identifying a particular vector, from among the first vectors, based on a similarity of the particular vector to the second vector and means for selecting a particular candidate path, from the plurality of candidate paths, that is represented by the particular vector identified based on the similarity of the particular vector to the second vector.

The apparatus of an example embodiment also includes means for converting an audio description of the specified path to the textual description, such as in real time or near real time. In an example embodiment, the means for defining the second vector includes means for defining the second vector based on one or more points of interest, one or more landmarks, one or more features of a map or one or more directions associated with the one or more segments of the specified path. The means for identifying the particular vector may include means for identifying the particular vector to be the most similar of the first vectors in comparison to the second vector. In an example embodiment, in an instance in which a length of an extended segment of the one or more segments exceeds a threshold, the means for defining the first vector that includes the extended segment that exceeds the threshold defines the first vector to include a plurality of elements that are each representative of the extended segment that exceeds the threshold.

In an example embodiment, the means for defining the first vector includes means for defining a respective first vector that includes a plurality of elements representative of the directional information associated with the one or more segments of the respective candidate path. In this example embodiment, the plurality of elements uniquely represent each point of interest or each direction associated with the one or more segments of the respective candidate path. The apparatus of an example embodiment also includes means for identifying a point of interest from the textual description, means for determining whether map data that includes the origin and the destination fails to represent the point of interest and means, in an instance in which the map data fails to represent the point of interest, for updating the map data to include the point of interest. In this example embodiment, the apparatus may also include means for updating the map data to include the point of interest by associating the point of interest with a location that is at least partially defined by the textual description from which the point of interest was identified. The location is represented by the map data in this example embodiment.

In an example embodiment, a method is provided for selecting a path to a destination. The method includes obtaining a second vector representative of an audio description of a specified path from an origin to the destination. The second vector includes a plurality of elements representative of one or more points of interest, one or more landmarks, one or more features of a map or one or more directions associated with the one or more segments of the specified path. The plurality of elements of the second vector are ordered sequentially based upon an ordering of the one or more points of interest, one or more landmarks, one or more features of a map or one or more directions associated with the one or more segments of the specified path. The method also includes identifying a particular vector, from among a plurality of first vectors representative of a plurality of respective candidate paths from the origin to the destination, based on a similarity of the particular vector to the second vector. The method further includes selecting a particular candidate path, from among the plurality of candidate paths, that is represented by the particular vector identified based on the similarity of the particular vector to the second vector.

The method of an example embodiment also includes converting the audio description of the specified path to a textual description and defining the second vector based upon the textual description of the specified path. In this example embodiment, the method converts the audio description by converting the audio description that is received in real time or near real time. In an example embodiment, the method further includes identifying a point of interest from the audio description, determining whether map data that includes the origin and the destination fails to represent the point of interest and, in an instance in which the map data fails to include the landmark, updating the map data to represent the point of interest.

In another example embodiment, an apparatus is provided for selecting a path to a destination. The apparatus includes processing circuitry and at least one memory including computer program code instructions with the computer program code instructions configured to, when executed by the processing circuitry, cause the apparatus to obtain a second vector representative of an audio description of a specified path from an origin to the destination. The second vector includes a plurality of elements representative of one or more points of interest, one or more landmarks, one or more features of a map or one or more directions associated with the one or more segments of the specified path. The plurality of elements of the second vector are ordered sequentially based upon an ordering of the one or more points of interest, one or more landmarks, one or more features of a map or one or more directions associated with the one or more segments of the specified path. The computer program code instructions are also configured to, when executed by the processing circuitry, cause the apparatus to identify a particular vector, from among a plurality of first vectors representative of a plurality of respective candidate paths from the origin to the destination, based on a similarity of the particular vector to the second vector. The computer program code instructions are further configured to, when executed by the processing circuitry, cause the apparatus to select a particular candidate path, from among the plurality of candidate paths, that is represented by the particular vector identified based on the similarity of the particular vector to the second vector.

The computer program code instructions are also configured to, when executed by the processing circuitry, cause the apparatus of an example embodiment to convert the audio description of the specified path to a textual description and to define the second vector based upon the textual description of the specified path. In this example embodiment, the computer program code instructions are configured to, when executed by the processing circuitry, cause the apparatus to convert the audio description by converting the audio description that is received in real time or near real time. In an example embodiment, the computer program code instructions are also configured to, when executed by the processing circuitry, cause the apparatus of an example embodiment to identify a point of interest from the audio description, determine whether map data that includes the origin and the destination fails to represent the point of interest and, in an instance in which the map data fails to include the landmark, update the map data to represent the point of interest.

In a further example embodiment, a computer program product is provided that is configured to select a path to a destination. The computer program product includes at least one non-transitory computer-readable storage medium having computer-executable program code instructions stored therein with the computer-executable program code instructions including program code instructions configured, upon execution, to obtain a second vector representative of an audio description of a specified path from an origin to the destination. The second vector includes a plurality of elements representative of one or more points of interest, one or more landmarks, one or more features of a map or one or more directions associated with the one or more segments of the specified path. The plurality of elements of the second vector are ordered sequentially based upon an ordering of the one or more points of interest, one or more landmarks, one or more features of a map or one or more directions associated with the one or more segments of the specified path. The computer-executable program code instructions also include program code instructions configured, upon execution, to identify a particular vector, from among a plurality of first vectors representative of a plurality of respective candidate paths from the origin to the destination, based on a similarity of the particular vector to the second vector. The computer-executable program code instructions further include program code instructions configured, upon execution, to select a particular candidate path, from among the plurality of candidate paths, that is represented by the particular vector identified based on the similarity of the particular vector to the second vector.

The computer-executable program code instructions of an example embodiment also include program code instructions configured, upon execution, to convert the audio description of the specified path to a textual description and defining the second vector based upon the textual description of the specified path. In this example embodiment, the program code instructions configured to convert the audio description include program code instructions configured to convert the audio description that is received in real time or near real time. In an example embodiment, the computer-executable program code instructions also include program code instructions configured, upon execution, to identify a point of interest from the audio description, determine whether map data that includes the origin and the destination fails to represent the point of interest and, in an instance in which the map data fails to include the landmark, update the map data to represent the point of interest.

In yet another example embodiment, an apparatus is provided for selecting a path to a destination. The apparatus includes means for obtaining a second vector representative of an audio description of a specified path from an origin to the destination. The second vector includes a plurality of elements representative of one or more points of interest, one or more landmarks, one or more features of a map or one or more directions associated with the one or more segments of the specified path. The plurality of elements of the second vector are ordered sequentially based upon an ordering of the one or more points of interest, one or more landmarks, one or more features of a map or one or more directions associated with the one or more segments of the specified path. The apparatus also includes means for identifying a particular vector, from among a plurality of first vectors representative of a plurality of respective candidate paths from the origin to the destination, based on a similarity of the particular vector to the second vector. The apparatus further includes means for selecting a particular candidate path, from among the plurality of candidate paths, that is represented by the particular vector identified based on the similarity of the particular vector to the second vector.

The apparatus of an example embodiment also includes means for converting the audio description of the specified path to a textual description and means for defining the second vector based upon the textual description of the specified path. In this example embodiment, the means for converting the audio description includes means for converting the audio description that is received in real time or near real time. In an example embodiment, the apparatus further includes means for identifying a point of interest from the audio description, means for determining whether map data that includes the origin and the destination fails to represent the point of interest and, in an instance in which the map data fails to include the landmark, means for updating the map data to represent the point of interest.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment of the present disclosure;

FIG. 2 is a flowchart illustrating operations performed, such as by the apparatus of FIG. 1, in order to select a path to a destination in accordance with an example embodiment of the present disclosure;

FIG. 3 is a representation of a map depicting a road network and a plurality of buildings;

FIG. 4 is another representation of the road network and the plurality of buildings of FIG. 3 following the overlay of a grid and the identification of the destination within the grid;

FIG. 5A depicts the road network of FIGS. 3 and 4 along with probe data including at least some probe points that lie between the origin and the destination;

FIG. 5B is an enlarged portion of a portion of FIG. 5A which illustrates a cluster of probe points along one side of a portion of the road network;

FIG. 6A is a graphical representation of a frequency histogram of a probe strand;

FIG. 6B is a graphical representation of the frequency histogram of FIG. 6A following convolution with a point spread function that serves to aggregate and amplify the peaks;

FIG. 6C is a graphical representation of the frequency histogram of FIG. 6B following the application of a threshold to the peaks;

FIG. 7 is a graphical representation of the definition of a first candidate route from an origin to a destination;

FIG. 8 is a graphical representation of the definition of a second candidate path from the origin to the destination;

FIGS. 9A and 9B illustrate points along two different candidate paths from an origin to a destination;

FIG. 10 illustrates a diagram of a geographic database, in accordance with an example implementation; and

FIG. 11 is a flowchart illustrating operations performed, such as by the apparatus of FIG. 1, in order to update map data to reference a point of interest identified from a textual description of a path in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment in order to select a path to a destination, such as for purposes of navigation. As described below, the path may be selected from a plurality of candidate paths and, in some embodiments, may provide the final portion of a route, such as the last mile, to the destination.

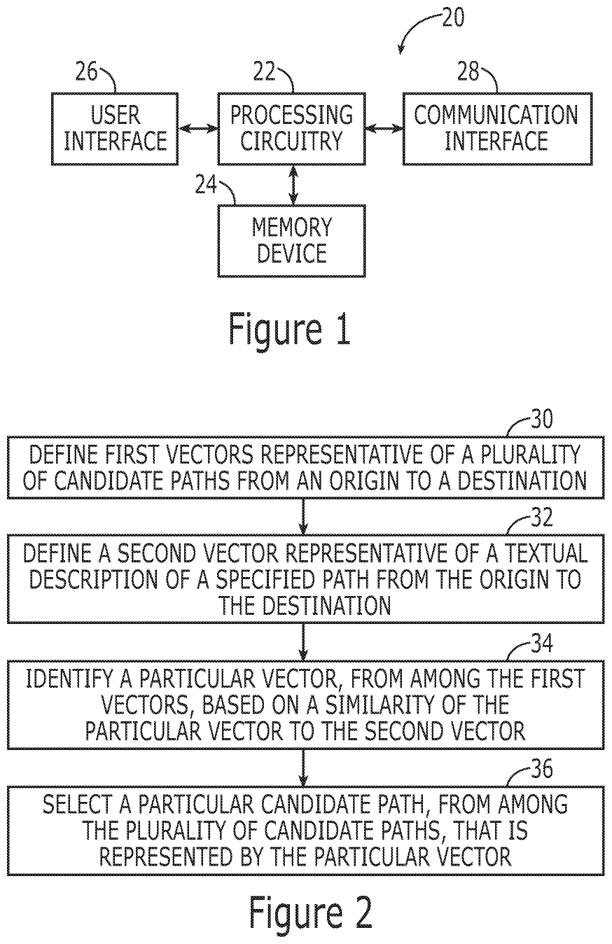

The apparatus configured to select a path to a destination, such as from among a plurality of candidate paths, may be embodied by any of a wide variety of computing devices including, for example, a server, a distributed network of computing devices, a navigation system, a mapping system, a computer workstation, a personal computer or any other type of computing device. Regardless of the manner in which the apparatus is embodied, the apparatus 20 of an example embodiment depicted in FIG. 1 may include, be associated with or be in communication with processing circuitry 22, a memory device 24 and optionally a user interface 26 and/or a communication interface 28.

In some embodiments, the processing circuitry 22 (and/or co-processors or any other processors assisting or otherwise associated with the processing circuitry) may be in communication with the memory device 24 via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processing circuitry.

The processing circuitry 22 may be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processor may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 22 may be configured to execute instructions stored in the memory device 24 or otherwise accessible to the processing circuitry. Alternatively or additionally, the processing circuitry may be configured to execute hard coded functionality. As such, whether configured by hardware or software methods, or by a combination thereof, the processing circuitry may represent an entity (for example, physically embodied in circuitry) capable of performing operations according to an embodiment of the present invention while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of software instructions, the instructions may specifically configure the processing circuitry to perform the algorithms and/or operations described herein when the instructions are executed. However, in some cases, the processing circuitry may be a processor of a specific device (for example, a computing device) configured to employ an embodiment of the present invention by further configuration of the processor by instructions for performing the algorithms and/or operations described herein. The processing circuitry may include, among other things, a clock, an arithmetic logic unit (ALU) and logic gates configured to support operation of the processing circuitry.

The apparatus 20 may also optionally include or otherwise be in communication with a user interface 26. The user interface may include a touch screen display, a keyboard, a mouse, a joystick or other input/output mechanisms. In some embodiments, the user interface, such as a display, speakers, or the like, may also be configured to provide output to the user. In this example embodiment, the processing circuitry 22 may comprise user interface circuitry configured to control at least some functions of one or more input/output mechanisms. The processing circuitry and/or user interface circuitry may be configured to control one or more functions of one or more input/output mechanisms through computer program instructions (for example, software and/or firmware) stored on a memory accessible to the processing circuitry (for example, memory device 24, and/or the like).

The apparatus 20 of an example embodiment may also optionally include a communication interface 28 that may be any means such as a device or circuitry embodied in either hardware or a combination of hardware and software that is configured to receive and/or transmit data from/to other electronic devices in communication with the apparatus, such as another memory device or a database as described below in conjunction with some example embodiments. Additionally or alternatively, the communication interface may be configured to communicate in accordance with various wireless protocols including Global System for Mobile Communications (GSM), such as but not limited to Long Term Evolution (LTE). In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s).

Referring now to FIG. 2, the operations performed, such as by the apparatus 20 of FIG. 1, in order to select a path to a destination are depicted. As shown in block 30, the apparatus of an example embodiment includes means, such as the processing circuitry 22 or the like, for defining a plurality of first vectors representative of a plurality of candidate paths from an origin to the destination. Each first vector may be a representative of a respective candidate path. The plurality of candidate paths may be provided in various manners. For example, the candidate paths may have been previously defined and stored, such as by memory device 24 or by another memory device or database accessible by the processing circuitry, such that the previously stored candidate paths may be readily accessed. In an example embodiment, however, the plurality of candidate paths are defined based upon map data defining a road network and building data, such as building data defining the shape of a plurality of buildings and the location of the plurality of buildings relative to the road network, as well as probe data. In this regard, the probe data is typically collected by a mobile device and is representative of the location of the mobile device at a respective point in time. By way of example, the mobile device that collects probe data may be the navigation, mapping or other onboard system of a vehicle or a mobile device, such as a smartphone, a personal data assistant, a personal navigation device or the like, carried by a passenger of a vehicle. Thus, probe data in the form of a plurality of probe points may be collected while a vehicle is traveling along a route. According to the example embodiment, each probe point of the probe data may include, without limitation, location data, (e.g. a latitudinal, longitudinal position, and/or height, global positioning system (GPS) coordinates, proximity readings associated with a radio frequency identification (RFID) tag, or the like), rate of travel, (e.g. speed), direction of travel, (e.g. heading, cardinal direction, or the like), device identifier, (e.g. vehicle identifier, user identifier, or the like), a time stamp associated with the data collection, or the like. The map data, the building data and/or the probe data may also be stored by memory device 24 or by another memory device or database accessible by the processing circuitry.

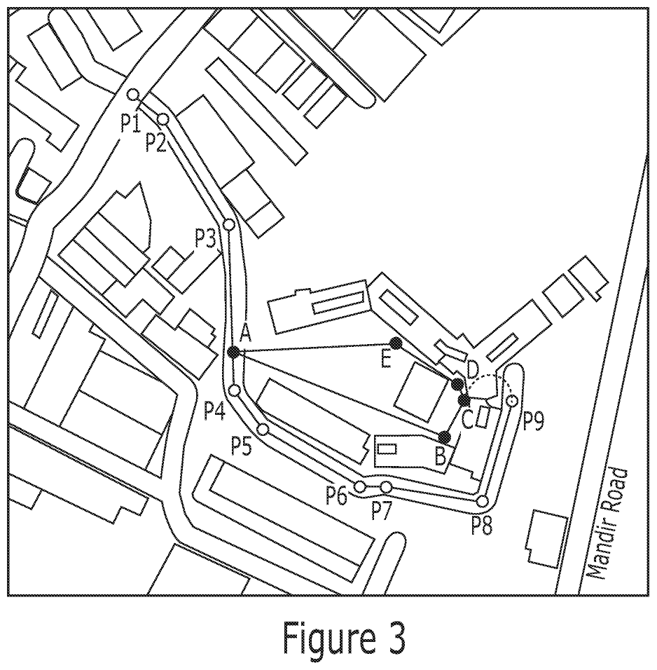

As shown in FIG. 3, the road network and buildings defined by the map data and the building data, respectively, are depicted in accordance with one example embodiment in which a path is to be defined from an origin designated P1 to a destination designated C. In an instance in which a path is defined to the closest point along the road network (the point designated P9) to the destination C, FIG. 3 illustrates that the destination C will not be reached and, instead, the destination C is spaced from the road network and is separated from Point P2 by at least one building.

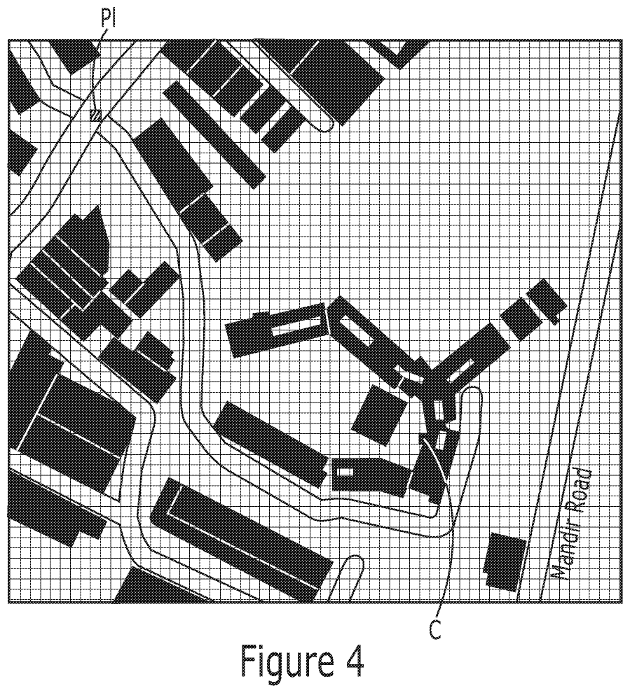

In order to define candidate paths from the origin to the destination in accordance with one example embodiment, the apparatus 20, such as the processing circuitry 22, is configured to apply a grid to the road network and buildings defined by the map data and the building data, respectively, such as shown in FIG. 4. Each grid element is a graphical node with the grid elements in which the origin and destination lie, serving as the start node and the end node. As also shown in FIG. 4, the apparatus, such as the processing circuitry, of this example embodiment is also configured apply a mask that defines the shapes of the buildings so as to overlie the buildings. The apparatus, such as the processing circuitry, of this example embodiment is then configured to identify each node as either being traversable or non-traversable, depending upon whether a node lies completely in an area that is masked by a building or is not completely masked by a building, respectively.

The apparatus 20, such as the processing circuitry 22, of this example embodiment is then configured to analyze the probe data in order to identify any interim points between the origin and the destination that must be traversed in order to reach the destination, such as a gate or other entrance to a building complex that must be entered in order to reach the destination. In order to identify these interim points, if any, the apparatus, such as the processing circuitry, is configured to analyze the probe data. In some embodiments, the apparatus, such as the processing circuitry, is configured to initially consider the quality of the probe data and to only utilize probe data having a quality that exceeds a predefined threshold or, alternatively, to weight the probe data based upon the associated quality of the probe data. For example, the apparatus, such as the processing circuitry, may be configured to weight the probe data in a manner that has a direct relationship to, such as by being proportional to, the quality. The quality of the probe data may be defined in various manners, but, in one embodiment, is defined by the vendor that provides the probe data.

The apparatus 20, such as the processing circuitry 22, of an example embodiment may also be configured to filter the probe data, such as by filtering the probe data so as to only utilize probe data for which the speed is 0 or, in other embodiments, probe data for which the speed is less than a predefined threshold, since a vehicle for which the probe data is collected must stop or otherwise appreciably slow in order to pass through a gate or another interim point that is to be identified between the origin and the destination.

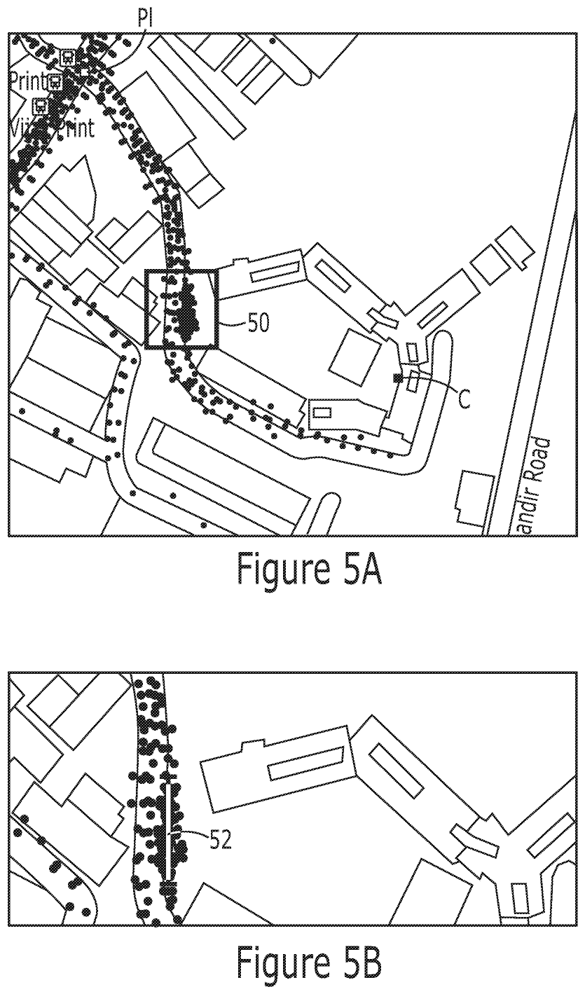

In this example embodiment, the apparatus 20, such as the processing circuitry 22, is also configured to map match the probe points, such as the probe points that have been qualified based upon quality and have been filtered based upon the associated speed, to respective road segments of the road network defined by the map data. See FIG. 5A. Although all probe points that have been map matched to the road network may subsequently be considered for purposes of the determination of probe density and the definition of probe strands, the apparatus, such as the processing circuitry, of an example further filters the probe points after the probe points have been map matched to the road network so as to identify and thereafter further process only those probe points located along a portion of a road segment. For example, as gates that are to be identified generally lie along the side or edge of a road segment, the apparatus, such as the processing circuitry, of one example embodiment is configured to filter out and remove the probe points that lie along the middle of a road segment such that the probe points that remain are those that lie along the edges of the road segments. The apparatus, such as the processing circuitry, of an example embodiment is then configured to evaluate the probe points, such as the remaining probe points if some of the map matched probe points have been filtered out, relative to the road network and to identify those region(s) that include the largest density of probe points, such as the region(s), if any, having a probe point density that satisfies, such as exceeds, a predefined threshold. In an embodiment in which the probe points have been weighted based upon the quality of the probe points, the weighting of the probe points may be taken into account in conjunction with the determination of the probe point density with a more greatly weighted probe point contributing more to the probe point density than a more lightly weighted probe point. The apparatus, such as the processing circuitry, of this example embodiment is then configured to define one or more probe strands, one of which extends through each respective region that has been identified to have a sufficiently large probe point density. The probe strand(s) that are defined extend in a direction parallel to the direction of the road segment that includes the region having a sufficiently large probe point density. See FIG. 5B which illustrates the definition of a probe strand 52 with a region designated 50 in FIG. 5A that has a sufficiently large probe point density.

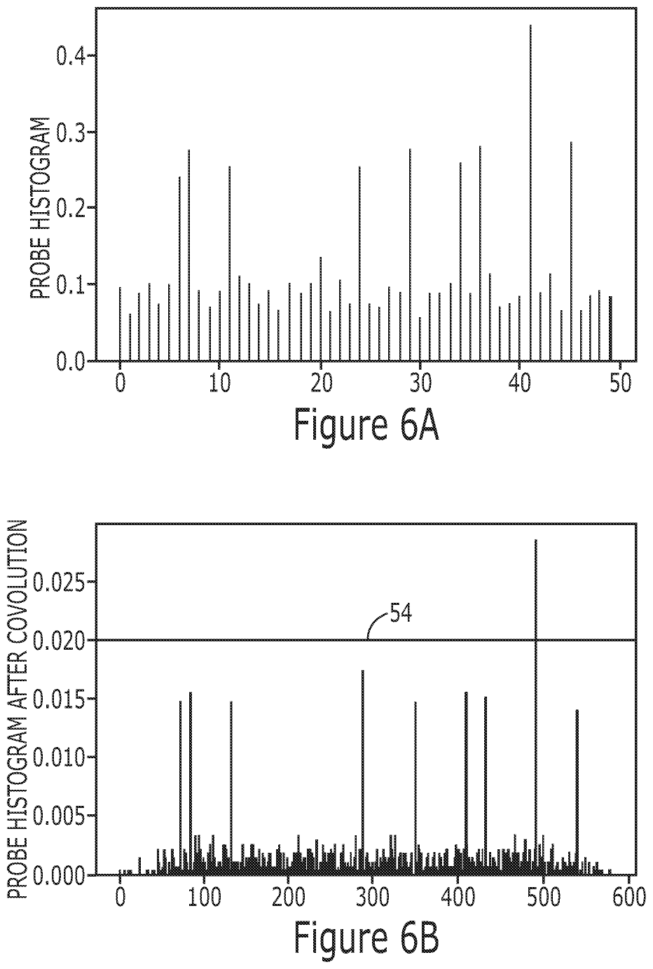

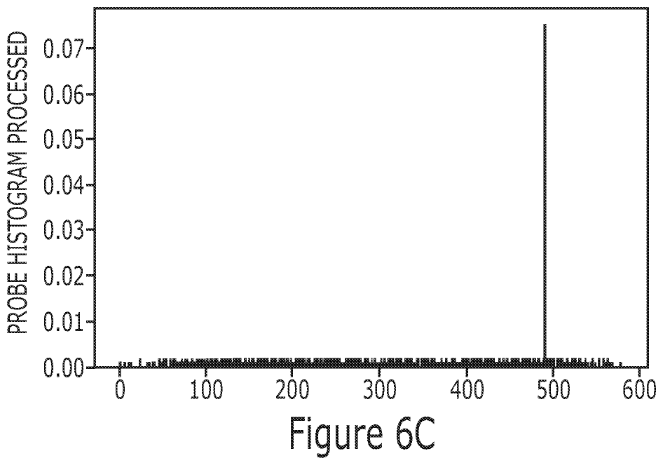

The apparatus 20, such as the processing circuitry 22, of this example embodiment is also configured to evaluate each probe strand. In this regard, the apparatus, such as the processing circuitry, is configured to create a frequency histogram representative of a respective probe strand with the horizontal axis defining a location along the probe strand and extending from the beginning of the probe strand designated 0 in FIG. 6A to the end of the probe strand designated 50 in FIG. 6A. At each of a plurality of positions along the probe strand, the frequency of the probe points is defined by the vertically extending bar. In this example embodiment, the apparatus, such as the processing circuitry, is also configured to apply convolution to the frequency histogram, such as the frequency histogram of FIG. 6A, with a point spread function to segregate and amplify the peaks. The result of the convolution of the frequency histogram of FIG. 6A is depicted in FIG. 6B, which illustrates fewer, but more well defined peaks. The apparatus, such as the processing circuitry, of this example embodiment is also configured to apply a threshold (designated as 54 in FIG. 6B) to the probe histogram following the convolution such that only those peaks that satisfy the threshold, such as by exceeding the threshold, remain so as to identify potential interim points, such as points along the respective probe strand at which a gate may be located, as shown in FIG. 6C. Like FIG. 6A, the horizontal axis represents the end to end distance of the probe strand with the distance being scaled in FIGS. 6B and 6C for illustration purposes. While the vertical axis of FIG. 6A represents the count of probe points, the vertical axes of FIGS. 6B and 6C have been scaled so as to depend upon the point spread function that is used for convolution. In this regard, the remaining peak(s) of the histogram that satisfy the threshold define respective locations along the probe strand of one or more interim points, such as one or more gates.

After evaluating the probe strands as described above in order to identify the potential locations of one or more interim points, such as the potential location of a gate that must be traversed to reach the destination, the apparatus 20, such as the processing circuitry 22, of an example embodiment is configured to then identify a plurality of candidate paths from the origin to the destination. In one example embodiment, the apparatus, such as the processing circuitry, is configured to utilize the probe point density to assign weights to the grid elements. In this regard, the occurrence of a probe point in a grid element indicates a greater chance of a path from the origin to the destination passing through the grid element such that the grid element is assigned a lower weight. In this example embodiment of a pathfinding algorithm, the weight assigned to a grid element is therefore inversely related, such as by being inversely proportional, to the number of probe points that lie within the respective grid element in order to reduce the cost of travelling along a path. By way of example, as the number of probe points within a grid element increases, the weight assigned to the grid element decreases and as the number of probe points within a grid element decreases, the weight assigned to the grid element increases.

The apparatus 20, such as the processing circuitry 22, of this example embodiment is then configured to define a candidate path from the origin to the destination using, for example, a weighted A* algorithm that operates based upon the weights assigned to the grid elements. The candidate path that results may also be subjected to the constraint that the candidate path passes through the interim point(s) that have been identified, such as by passing through a location identified as a gate. As a result of the relatively high density of probe points within the grid element(s) that include an interim point, the definition of the candidate path utilizing, for example, the weighted A* algorithm has a substantial likelihood of including the interim point within the candidate path without any additional processing to ensure that the interim point is included. If, however, the interim point is not included within the candidate path, the apparatus, such as the processing circuitry, of an example embodiment may be configured to revise the candidate path so as to pass through the interim point between the origin and destination. In this example embodiment, multiple candidate paths may be defined based upon the analysis of different sets or combinations of probe points.

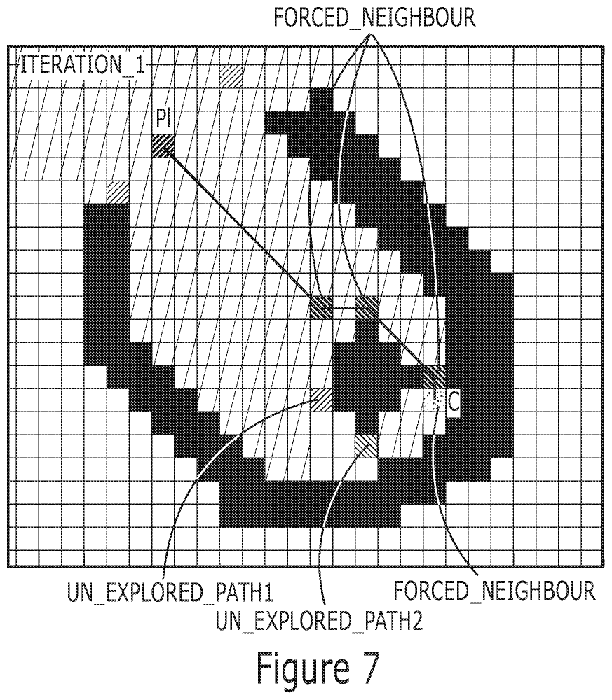

The candidate paths may be defined in other manners. For example, in instances in which probe data is more limited, the apparatus 20, such as the processing circuitry 22, may be configured to utilize the Jump Point Search (JPS) algorithm in order to determine a plurality of candidate paths between the origin and the destination by iterating over the paths as described below. As shown in FIG. 7, a map having a grid applied thereto as described above and including one or more non-navigable areas, such as defined by buildings or other structures that prevent navigation, are represented by the grid elements of FIG. 7 that are shaded more darkly. In this context, the apparatus, such as the processing circuitry, is configured to define a first path from the grid element that includes the origin designated A in FIG. 7 to the grid element that includes destination designated C. In accordance with the JPS algorithm, the apparatus, such as the processing circuitry, is configured to define the path from the origin to the destination that passes through one or more intermediate grid elements that are identified to be forced neighbors as also shown in FIG. 7. The unexplored grids indicate possible new paths that can be found out by iterating using a JPS over these intermediate grids that were skipped by the initial iteration of the JPS.

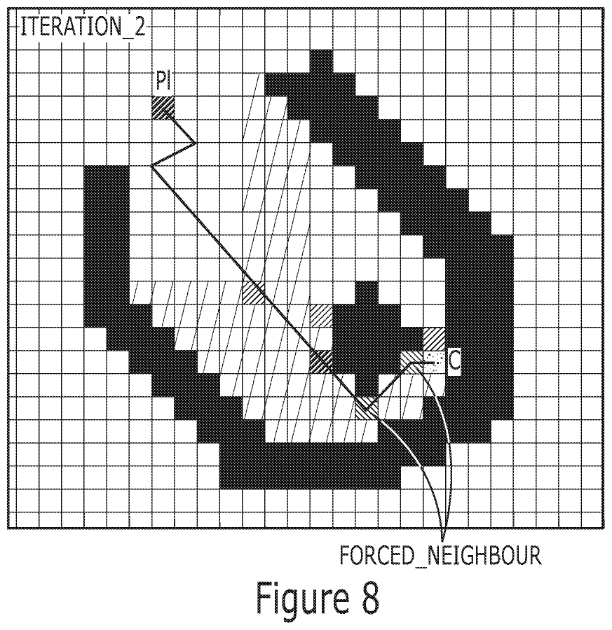

In accordance with the JPS algorithm, the apparatus 20, such as the processing circuitry 22, is then configured to iterate over one or more un-explored paths from the origin to the destination. In defining a second candidate path, for example, the apparatus, such as the processing circuitry, is configured to define the second candidate path in accordance with the JPS algorithm to extend from the origin to the destination and through one or more intermediate grid elements that are designated to be forced neighbors, although different forced neighbors than those utilized in conjunction with the definition of the first candidate path. The second candidate path is shown in FIG. 8. Although the grid elements that are designated to be forced neighbors may be identified in various manners, the apparatus, such as the processing circuitry, of an example embodiment is configured to identify the grids that are forced neighbors based upon the weights associated with the grid elements as a result of the analysis of the density of the probe points associated with each grid element as described above.

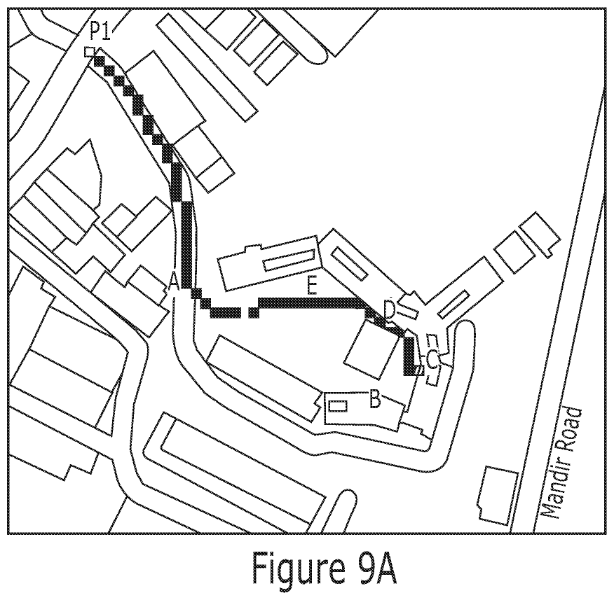

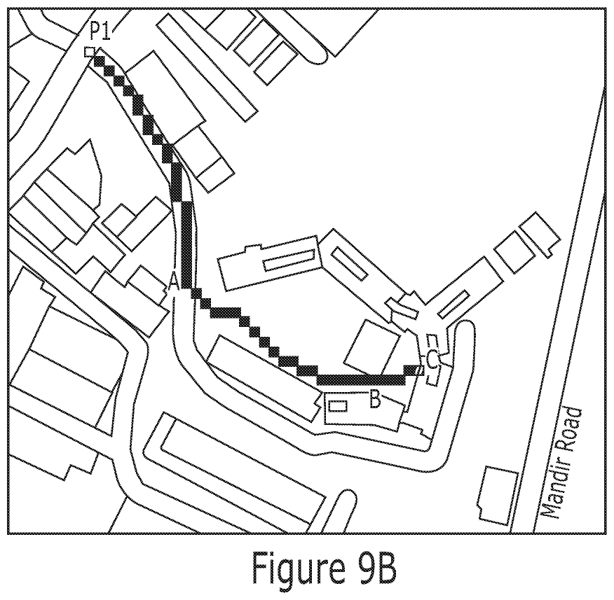

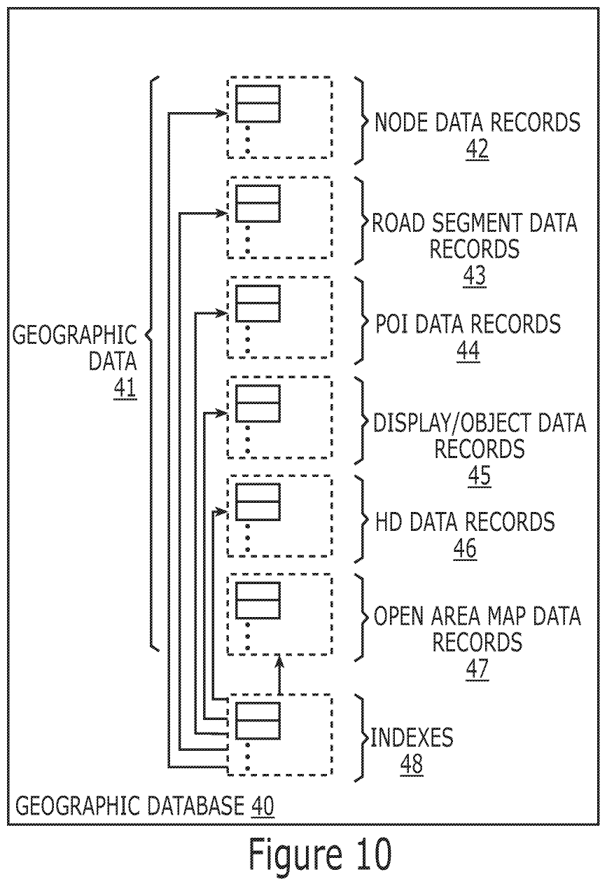

Regardless of the manner in which the candidate paths are defined, the apparatus 20, such as the processing circuitry 22, is configured to store a representation of the plurality of candidate paths, such as the shortest n paths from the origin to the destination that are semantically different from one other. In the forgoing example utilizing the JPS algorithm, two different candidate paths are defined with a first candidate path defined as path P1-A-E-D-C and the second candidate path defined as path P1-A-B-C as represented in FIGS. 9A and 9B, respectively. However, the apparatus, such as the processing circuitry, may be configured to define the candidate paths in different manners, to define different numbers of candidate paths and/or to utilize one or more predefined candidate paths.

Returning now to block 30 of FIG. 2, the apparatus 20, such as the processing circuitry 22, is configured to define first vectors representative of a plurality of respective candidate paths from the origin to the destination. In an example embodiment, a first vector is defined to be representative of each respective candidate path. Thus, in the forgoing example having two candidate paths, one first vector is defined to be representative of the first candidate path and another first vector is defined to be representative of the second candidate path. Additional first vectors may be defined in instances in which three or more candidate paths are to be represented.

The apparatus 20, such as the processing circuitry 22, is configured to define the first vectors such that each first vector is at least partially defined by directional information associated with one more segments of the respective candidate path. By way of example and with the reference to the candidate path that extends from the origin P1 and sequentially through A, E and D to the destination C, the apparatus, such as the processing circuitry, is configured to the define the first vector to include a representation of the origin and then a series of directions associated with the sequentially ordered segments of the candidate path prior to concluding with a representation of the destination. With reference to path P1-A-E-D-C as shown in FIG. 9A, the apparatus, such as the processing circuitry, of an example embodiment is configured to define the first vector to be [“p1”, “straight”, “straight”, “left”, “left”, “left”, “straight”, “right”, “destination”]. In this example, each element in the first vector may be represented by a corresponding number, character or other symbol. For example, the origin may be designated as 0 and destination may be designated as 9. In addition, each of the different directions such as, straight, left and right may be also be represented by a corresponding number, such as 1, 2 and 3 respectively. Thus, the apparatus, such as the processing circuitry, may be configured to define the first vector representative of path P1-A-E-D-C of FIG. 9A as [0,1,1,2,2,1,3,9].

By way of further explanation of this first vector representative of a first candidate path, the first vector begins with the origin 0 and then extends along the first segment of the first candidate path between points P1 and A in a straight direction. In an example embodiment, in an instance in which the length of a segment exceeds a distance threshold, such as a predefined number of grid elements, e.g., 5 grid elements, the segment may be designated as an extended segment. In this instance, the apparatus 20, such as the processing circuitry 22, of an example embodiment is configured to define the first vector and, more particularly, the element(s) of the first vector that represent the extended segment that exceeds the threshold to include not just a single element that is representative of the segment, but a plurality of elements that are each representative the extended segment that exceeds the threshold. In one example embodiment, the length of the extended segment may be divided by the threshold and the whole number portion of the quotient that results may be utilized to define the number of elements of the first vector that will represent the extended segment. In the foregoing example regarding the first candidate path from FIG. 9A, the segment of the first candidate path that extends from the origin to point A is an extended segment that is to be represented by two elements of the first vector. Thus, the first vector includes a first element that represents the origin and then two elements that each designated as “straight” to represent proceeding along a straight direction from the origin to point A over an extended distance.

In this example regarding the definition of the first vector representative of the first candidate path, the first vector then includes an element “left” indicating the direction to be taken from point A to proceed toward point E. As this segment of the candidate path that extends from point A to point E also exceeds the distance threshold, the first vector again repeats the element of “left” to provide directions from point A to point E. This first vector then includes an element of “straight” indicating the direction to proceed from point E to point D and then an element indicating to turn “right” in order to proceed from point D to the destination designated as point C. In an instance in which the origin is designated as 0, the destination is designated as 9 and straight, left and right are designated 1,2, and 3, respectively, the resulting first vector for the first candidate path is [0,1,1,2,2,1,3,9] in this example.

Similarly, the apparatus 20, such as the processing circuitry 22, is configured to define a first vector for each of the other candidate paths. In the foregoing example, the second candidate path is defined from the origin through points A and B to the destination C as shown in FIG. 9B. In this example, the apparatus, such as the processing circuitry, is configured to define a first vector representative of the second candidate path as [0,1,1,2,1,1,1,9]. More particularly, the first vector representative of the second candidate path begins with the origin designated 0 and then includes two consecutive “straight” elements that are representative of the extended segment that extends from the origin to point A in a straight direction and that has a length that exceeds the distance threshold. The first vector representative of the second candidate path then includes an element of “left” indicating the direction to be taken to proceed from point A to B followed by two additional elements of “straight” representative of the direction to be taken to proceed to point B after having taken the left turn since the segment that extends from point A to point B is an extended segment that has a length that exceeds the distance threshold, such as a predefined number of grid elements. The first vector then includes an element of “left” to indicate the direction to be turned to proceed from point B to the destination designated C. Thus, the resulting first vector representative of the second candidate path is [0,1,1,1,2,1,1,1,9].

Thus, the apparatus 20, such as the processing circuitry 22, of this example embodiment is configured to define the first vector to include a plurality of elements representative of the directional information associated with the one or more segments of the respective candidate path. For example, the first vectors described above by way of example include directional information in the form of “straight”, “left” and “right” to indicate the directions to be taken along different segments of the respective candidate path. As the first vectors described above exemplify, the plurality of elements of a respective first vector uniquely represent each point of interest or each direction associated with the one or more segments of the respective candidate path. In this regard, the first vectors that were described ab above by way of example include elements that identify two points of interest, namely, the origin and the destination, as well as the direction to be taken to proceed from one point to another point along the respective candidate path.

As shown in block in 32 of FIG. 2, the apparatus 20 of an example embodiment also includes means, such as the processing circuitry 22 or the like, configured to define a second vector representative of a textual description of a specified path from the origin to the destination. The textual description from which the second vector is defined may be provided in various manners. For example, a person located at the intended destination or a person who previously drove and navigated to the intended destination may provide a textual description of the route to be taken or at least a portion of the route to be taken, such as the last mile of the route. This textual description may be provided in various manners including in the form of an electronic message, a text message or like. Alternatively, an audio description of the specified path may initially be provided, such as by a person located at the destination or a person who previously drove and navigated to the destination. In this example embodiment, the apparatus, such as the processing circuitry, is configured to convert the audio description of the specified path to a corresponding textual description. The apparatus, such as the processing circuitry, may be configured to convert the audio description of the specified path to the corresponding textual description in various manners including by utilizing the DeepSpeech automatic speech recognition engine provided by Mozilla or the Speech to Text application programming interface (API) provided by IBM.

The conversion of the audio description of the specified path to the textual description may be performed in real time or near real time relative to the time at which the audio description is provided. Alternatively, the audio description may have been provided at an earlier point in time, such as by a driver who previously drove and navigated to the destination, with the prior audio description then being converted at some later point in time, such as at the time at which another driver desires to drive and navigate to the same destination. Thus, the audio description may be stored, as in the memory device 24 or in another memory or database accessible to the processing circuitry 22, for subsequent access by the processing circuitry.

In order to define the second vector representative of the textual description of the specified path from the origin to the destination, the apparatus 20, such as the processing circuitry 22, is configured to process the textual description and to recognize a plurality of different terminology within the textual description including one or more points of interest, one or more landmarks, one or more features of map and/or one or more directions associated with one or more segments of the specified path. The apparatus, such as the processing circuitry, may be configured to process the textual description in various manners, but, in an example embodiment is configured to process the textual description utilizing natural language processing. Thus, the apparatus, such as the processing circuitry, of an example embodiment may include a neural network, such as a neural network phased sequence to sequence transform module, that is configured to identify the terminology of interest from the textual description.

The apparatus 20, such as the processing circuitry 22, of this example embodiment is configured to not only identify the terminology from the textual description, but to identify the sequence in which the terminology is utilized by the textual description and to store representations of the terminology in the same sequence, such as in the memory device 24. Based upon the terminology that is identified from the textual description regarding one or more points of interest, one more landmarks, one or more features of map and/or one or more directions associated with one or more segments of the specified path, the apparatus, such as the processing circuitry, is configured to define the second vector so as to represent the origin, the destination and directional information associated with the segments of the specified path between the origin and the destination in the same sequential manner that the segments are ordered from the origin to the destination. In an example embodiment, the apparatus, such as the processing circuitry, is configured to define the second vector representative of the specified path in the same manner as described above with respect to the definition of the first vectors with an element representative of the origin, elements representative of the sequence of directions to be taken along the ordered segments of the specified path and then a final element representative of the destination. As such, the second vector is at least partially defined by directional information associated with one or more segments of the specified path and, more particularly, is based on one or more points of interest, one or more landmarks, one or features of a map and/or one or more directions associated with the one or more segments of the specified path.

As shown in block 34 of FIG. 2, the apparatus 20 of an example embodiment also include means, such as the processing circuitry 22 or the like, for identifying a particular vector, from among the first vectors based on a similarity of the particular vector to the second vector. In an example embodiment, the apparatus, such as the processing circuitry, is configured to individually compare each of the first vectors to the second vector in order to determine the similarity between a respective first vector and the second vector. The apparatus, such as the processing circuitry, of this example embodiment is further configured to identify the particular vector to the first vector that is the most similar from among the plurality of first vectors in comparison to the second vector.

The apparatus 20, such as the processing circuitry 22, may be configured to define the similarity between a respective first vector and the second vector in various manners. In an example embodiment, however, the apparatus, such as the processing circuitry, is configured to determine the cosign similarity between a respective first vector and the second vector in order to determine a measure of similarity between the two vectors. In this example embodiment, the apparatus, such as the processing circuitry, is configured to define the similarity between a respective first vector A and a second vector B with each vector having n elements as follows:

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} ,$$

In order to facilitate the foregoing comparison, the apparatus 20, such as the processing circuitry 22, is configured to define the first and second vectors that are being compared so as to have the same number of elements. Thus, in an instance in which either the respective first vector or the second vector has a different number of elements than the other vector, the apparatus, such as the processing circuitry, of an example embodiment is configured to add element(s) to the shorter of the vectors, such as by padding the shorter of the second vector or the respective first vector with, for example, one or more additional elements added to the end of the vector and set to a value of 0, in order for the resulting respective first vector and the second vector to have the same dimensions. The apparatus, such as the processing circuitry of an example embodiment may alternatively be configured to modify the dimensions of the second vector or the respective first vector such that the second vector and respective first vector have the same number of elements in other manners, such as by utilizing Principal Component Analysis (PCA).

As shown in block 36 of FIG. 2, the apparatus 20 of an example embodiment also includes means, such as the processing circuitry 22 or the like, for selecting a particular candidate path, from among the plurality of candidate paths, that is represented by the particular vector identified based on the similarity of the particular vector to the second vector. In this regard, the apparatus, such as the processing circuitry, is configured to select the particular candidate path that is represented by the first vector that is most similar to the second vector. Thus, the particular candidate path that is selected will be the closest match to the specified path that is provided by the textual description that serves to define the second vector.

Following selection of the particular candidate path, a route including the particular candidate path may be provided, such as via the user interface 26 or by a navigation system in communication with the apparatus 20. In this regard, the route including the particular candidate path may be presented upon a display and/or may be presented audibly, such as via one or more speakers, to a driver to facilitate navigation to the destination. As a result of the correlation of the second vector to a respective first vector and, in turn, to the particular candidate path that is selected, the particular candidate path will be defined based upon map data so as to be defined in a complete manner and in a manner that is consistent with other portions of the route that are also based upon the map data, as opposed to being defined with potentially different terminology and in a different level of detail as provided by the textual description of the specified path. Thus, the likelihood that the navigation directions, including those over the last mile of a route, will be coherent and integrated with the directions over other portions of the overall route, is increased.

In an example embodiment, the map data may be stored by a geographic database 40 accessible by the processing circuitry 22. Geographic database could be included within, integrated with, or be separate from another database, data storage device, memory, or the like described herein (e.g., memory 24). Additionally or alternatively, geographic database could be stored on or otherwise made accessible to any entity described herein, such as via the communication interface 28, without departing from the scope of the present disclosure. Moreover, although certain aspects of the geographic database are described in the context of outdoor mapping and/or outdoor navigation-related services, it should be understand that some or all such aspects could extend to apply in the context of indoor mapping and/or indoor navigation-related services.

More specifically, the geographic database 40 may include geographic data 41 used for (or configured to be compiled to be used for) mapping and/or navigation-related services. For instance, the geographic database may include high resolution or high definition (HD) mapping data that provide centimeter-level or better accuracy of map features. By way of example, the geographic database can be based at least in part on Light Detection and Ranging (LiDAR) and/or other technology to collect billions of 3D points and model road surfaces (and/or other map features down), e.g., to the number lanes and their widths. In some cases, the HD mapping data (e.g., HD data records 46) may capture and store details such as the slope and curvature of the road, lane markings, roadside objects such as sign posts, including what the signage denotes, and/or shape/sizes of indoor objects, hallways, rooms etc. In practice, the HD mapping data may enable precise localization of an entity on a road and/or in a building, and/or may enable determination of map data updates (e.g., learned speed limit values) to at high accuracy levels, among other options.

In the geographic database 40, geographic features (e.g., two-dimensional or three-dimensional features) may be represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In this regard, the following terminology may apply to the representation of geographic features in the geographic database 40.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In an example implementation, the geographic database 40 may follow certain conventions. For example, links might not cross themselves and might not cross each other except at a node. Also, there may be no duplicated shape points, nodes, or links. Two links that connect each other may have a common node. In the geographic database, overlapping geographic features may be represented by overlapping polygons. When polygons overlap, the boundary of one polygon may cross the boundary of the other polygon. In the geographic database, the location at which the boundary of one polygon intersects the boundary of another polygon may be represented by a node. In an embodiment, a node may be used to represent other locations along the boundary of a polygon than a location at which the boundary of the polygon intersects the boundary of another polygon. Additionally or alternatively, a shape point may not be used to represent a point at which the boundary of a polygon intersects the boundary of another polygon.

In an example implementation, the geographic database 40 may be stored as a hierarchical or multi-level tile-based projection or structure. More specifically, in one embodiment, the geographic database may be defined according to a normalized Mercator projection. Other projections may be used. By way of example, the map tile grid of a Mercator or similar projection may be a multilevel grid. Each cell or tile in a level of the map tile grid may be divisible into the same number of tiles of that same level of grid. In other words, the initial level of the map tile grid (e.g., a level at the lowest zoom level) may be divisible into four cells or rectangles. Each of those cells are in turn divisible into four cells, and so on until the highest zoom or resolution level of the projection is reached.

In some implementations, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. Further, each cell may be divided into four rectangles and numbered by concatenating the parent tile ID and the new tile position. A variety of numbering schemes also is possible. Any number of levels with increasingly smaller geographic areas may represent the map tile grid. Any level (n) of the map tile grid may have 2(n+1) cells. Accordingly, any tile of the level (n) has a geographic area of A/2(n+1) where A is the total geographic area of the world or the total area of the map tile grid 10. Because of the numbering system, the exact position of any tile in any level of the map tile grid or projection may be uniquely determined from the tile ID.

In this regard, a system may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid 10. In an embodiment, the quadkey is an example of the hash or encoding scheme of the respective geographical coordinates of a geographical data point that can be used to identify a tile in which the geographical data point is located.

As shown, the geographic database 40 may include node data records 42, road segment or link data records 43, Points of Interest (POI) data records 44, display/object data records 45, HD mapping data records 46, open area map data records 47, and indexes 48, for example. More, fewer or different data records can be provided. For example, other data records can include cartographic data records, routing data, and/or maneuver data. Further, the indexes may improve the speed of data retrieval operations in the geographic database. For instance, the indexes may be used to quickly locate data without having to search every row in the geographic database every time it is accessed. For example, in one embodiment, the indexes can be a spatial index of the polygon points associated with stored feature polygons.

In example embodiments, the road segment data records 43 may be links or segments representing roads, streets, or paths, as can be used in a calculated or recorded route information for determination of one or more personalized routes. The node data records 42 may be end points corresponding to the respective links or segments of the road segment data records. The road link data records and the node data records may represent a road network, such as used by vehicles, cars, and/or other entities. Alternatively, the geographic database 40 can contain path segment(s) and node data records or other data that represent pedestrian paths or areas in addition to or instead of the vehicle road record data (e.g., paths and/or areas for indoor and/or outdoor positioning and/or navigation), for example.

The road/link segments and nodes can be associated with attributes, such as geographic coordinates, street names, address ranges, speed limits, turn restrictions at intersections, and other navigation related attributes, room names/identifiers, vertical connector names/identifiers, as well as POIs, such as gasoline stations, hotels, restaurants, museums, stadiums, offices, automobile dealerships, auto repair shops, buildings, stores, parks, interior building features etc. The geographic database 40 can include data about the POIs and their respective locations in the POI data records 44. The geographic database can also include data about places, such as cities, towns, or other communities, and other geographic features, such as bodies of water, mountain ranges, etc. Such place or feature data can be part of the POI data records 44 or can be associated with POIs or POI data records (such as a data point used for displaying or representing a position of a city). Other examples are also possible.

In some implementations, the geographic database 40 can include display/object data records 45 for storing machine-readable visual representations and map data decoded from the visual representations and their respective properties. In addition, the display/object data records can store post-processing rule sets for correcting and/or reducing the uncertainties in the display/object data decoded from clustered machine-readable visual representations. The display/object data records can also store data selection rules (e.g., in a map data extension layer) for selecting from among multiple sets of readings of a machine-readable visual representation. The display/object data records can also store confidence or accuracy determinations for the decoded map data. By way of example, the display/object data records can be associated with one or more of the node records 42, road segment records 43, and/or POI data records 44 to support uses cases such as enhanced mapping user interfaces (UIs), autonomous driving, dynamic map updates, etc. In some cases, the display/object data records may be stored as a data layer of the hierarchical tile-based structure of the geographic database according to the various embodiments described herein.

In some implementations, as discussed above, the HD mapping data records 46 could model map features to centimeter-level or better accuracy. The HD mapping data records may be divided into spatial partitions of varying sizes to provide HD mapping data to vehicles and/or other devices with near real-time speed without overloading the available resources of the vehicles and/or devices (e.g., computational, memory, bandwidth, etc. resources).

In an example implementation, the geographic database 40 can be maintained by a content provider in association with a services platform (e.g., a map developer). The map developer can collect geographic data to generate and/or enhance the geographic database. There can be different ways used by the map developer to collect data. These ways can include obtaining data from other sources, such as municipalities or respective geographic authorities. Additionally or alternatively, the map developer can employ field personnel to travel along roads and/or inside buildings (or other indoor areas) throughout the geographic region to observe features and/or record information about them, for example. Additionally or alternatively, remote sensing, such as aerial or satellite photography, can be used.

Generally, the geographic database 40 can be a master geographic database stored in a format that facilitates updating, maintenance, and/or development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data can be compiled (such as into a platform specification format (PSF)) to organize and/or configure the data for performing navigation-related functions and/or services, such as route calculation, route guidance, map display, speed calculation, distance and travel time functions, and other functions, by a navigation or other device. The navigation-related functions can correspond to vehicle navigation, pedestrian navigation, or other types of navigation. The compilation to produce end user databases can be performed by a party or entity separate from the map developer. For instance, a customer of the map developer, such as a navigation device or other end user device developer, can perform compilation on a received geographic database in a delivery format to produce one or more compiled navigation databases.

In a further aspect, as noted, the geographic database 40 could additionally or alternatively include open area map data record(s) 47 for open area map(s). Generally speaking, open area map(s) may include image(s) or the like of respective layout(s) representing pedestrian walkable area(s) (e.g., indoor area(s), such as one or more floors of a building), and may be configured, separately or together, to enable or otherwise provide point-to-point routing within the layout(s). For example, in line with the discussion above, a radio map could include, be combined with, or otherwise correspond to an open area map representing features of an indoor and/or outdoor area at various locations in the area, to enable positioning and/or navigation solution(s) for the area. Other examples are also possible.

In an example implementation, an open area map may be positioned in, on, or over a geographic map or database (e.g., geographic database 40). The geographic map may be or include geographic data (e.g., any feasible data from records 42-46) corresponding to an area other than (or perhaps at least partially overlapping with) the area represented in the open area map. Also, the geographic map may represent compiled data that corresponds to a database or map configured for vehicle and/or pedestrian navigation. Alternatively, the geographic map may correspond to any real-world or geographic map or data that may or may not be used for navigation or routing. In any case, the geographic map may, e.g., include, but is not limited to, a road network. The road network may represent real-world roads or paths, such as in a city or other geographic region. Navigation attributes and POIs may also be provided.

In this regard, the open area map may be associated or linked with the geographic map or data. For example, one or more points or coordinates of the open area map may be aligned or positioned in or with one or more points or coordinates of the geographic map or data. In one embodiment, coordinates corresponding to tiles, objects, or other portion of the open area map may be in, translated to, or converted to real-world coordinates, such as longitude or latitude, Universal Transverse Mercator (“UTM”) coordinates, or other rectangular or 3D coordinates, such as altitude or elevation points. Based on the real-world coordinates, the open area map or data thereof may be placed, positioned, or aligned with or within the geographic map.

For example, nodes, segments, or other features of the geographic map may correspond to real-world coordinates, such as longitude, latitude, and/or UTM coordinates as well as elevation or altitude information. Accordingly, by knowing the real-world coordinates of the open area map, the open area map may be accurately linked to a real-world position or location in the geographic map (e.g., geographic database 40 and/or a display). Additionally or alternatively, the coordinates or points of the open area map or data thereof may be linked or associated with a road network, such as road segments, nodes, and/or other features, without reference to real-world coordinates.

Given this, an end user may perform point-to-point routing using the open area map while viewing a surrounding geographic area or map. Also, the open area map may be linked to the geographic map for navigation or routing purposes, such as via point or navigation data.

For example, an end user may want to navigate or route from inside the open area map to a point external to the open area map that is covered in the geographic map, or vice versa (e.g., an indoor-to-outdoor transition and/or an outdoor-to-indoor transition). Accordingly, a route may be calculated and/or displayed in the open area map (e.g., in the context of indoor navigation), and then from a transition point or area, the route or second route (a continuing route to a selected destination outside of the open area map) may be calculated and/or displayed based on route calculation of the geographic map.

In this regard, in some cases, the navigation or routing of the geographic map may be different than the point-to-point routing of the open area map. For example, the routing of the geographic map may be based on vehicle and/or pedestrian navigation attributes of set roadways, and the routing of the open area map may be based on pedestrian navigation attributes of set indoor features (e.g., hallways, lobbies, rooms etc.) But in other cases, the navigation or routing of the geographic map could be the same as or similar to the point-to-point routing of the open area map.

In any case, in other implementations, an open area map may be positioned in or associated with the geographic map without being linked or tied in with navigation or routing features or functions of the geographic map. Namely, the routing or navigation of at least some open area map(s) may be independent or separate from routing or navigation of an associated geographic map. Other examples and aspects are also possible.

Although described heretofore in relation to the definition of a second vector representative of the textual description of a specified path, the second vector may, in some embodiments, have been previously defined, such as in response to a textual description of specified path and/or in response to an audio description of a specified path from the origin to the destination. In this embodiment, the apparatus 20, such as the processing circuitry 22, is configured to obtain the second vector representative of the specified path from the origin to the destination, such as by accessing a representation the second vector stored by the memory device 24 or by another memory device or database to which the processing circuitry has access. Thereafter, the apparatus, such as the processing circuitry, is configured to identify the particular vector, from among the plurality of first vectors representative of a plurality of candidate paths from the origin to the destination, based on the similarity of the particular vector to the second vector and to then select a particular candidate path from among the plurality of candidate paths as represented by the particular vector identified based on the similarity of the particular vector to the second vector, as described above.

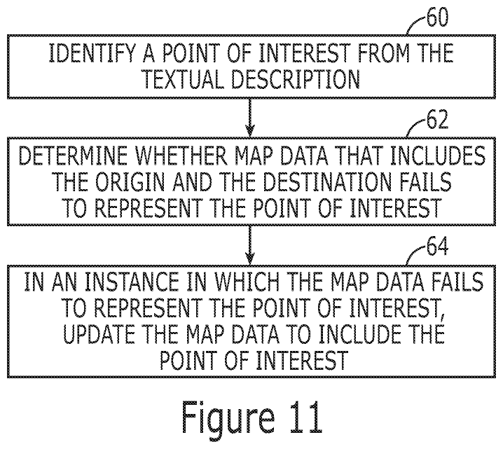

In an example embodiment, the apparatus 20, such as the processing circuitry 22, is additionally configured to utilize the results of the analysis of the textual description of the specified path to determine if the map data that has been utilized in order to define the candidate paths includes each of the same points of interest and, in an instance in which the map data fails to include each of the same points of interest, to update the map data to also include the points of interest. As shown in block 60 of FIG. 11, the apparatus of this example embodiment includes means, such as the processing circuitry or the like, for identifying a point of interest from the textual description of a specified path. In this context, reference to a point of interest should be taken broadly so as to include a variety of points interest including landmarks or other features that are typically included in map data. In this example embodiment, the apparatus, such as the processing circuitry, is configured to identify the point of interest from the textual description in various manners by utilization of natural language processing, such as a neural network implementing natural language processing as described above.

As shown in block 62 of FIG. 11, the apparatus 20 of this example embodiment also includes means, such as the processing circuitry 22 or the like, for determining whether map data that includes the origin or the destination fails to represent the point of interest identified from the textual description. In an instance in which the map data fails to represent the point of interest, the apparatus of this example embodiment also includes means, such as the processing circuitry or the like, for updating the map data to include the point of interest. See block 64 of FIG. 11. In relation to updating the map data, the apparatus, such as the processing circuitry, of an example embodiment is configured to associate the point of interest with a location (represented by the map data) that is at least partially defined by the textual description from which the point of interest was identified. Thus, the apparatus, such as the processing circuitry, of this example embodiment is configured to update the map data based upon additional information that has been provided, such as by a person located at the intended destination, by a driver who previously drove and navigated to the intended destination or by some other source, such that resulting map data is more inclusive and representative, thereby improving the candidate paths subsequently defined based upon the map data.

FIGS. 2 and 11 illustrate flowcharts depicting a method according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by the processing circuitry 22. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for selecting a path to a destination, the method comprising:
defining first vectors representative of a plurality of respective candidate paths from an origin to the destination, wherein each first vector is at least partially defined by directional information associated with one or more segments of the respective candidate path;
defining a second vector representative of a textual description of a specified path from the origin to the destination, wherein the second vector is at least partially defined by directional information associated with one or more segments of the specified path;
identifying a particular vector, from among the first vectors, based on a similarity of the particular vector to the second vector; and
selecting a particular candidate path, from among the plurality of candidate paths, that is represented by the particular vector identified based on the similarity of the particular vector to the second vector.

2. A method according to claim 1, further comprising converting an audio description of the specified path to the textual description.

3. A method according to claim 2, wherein converting the audio description comprises converting the audio description that is received in real time or near real time.

4. A method according to claim 1, wherein defining the second vector comprises defining the second vector based on one or more points of interest, one or more landmarks, one or more features of a map or one or more directions associated with the one or more segments of the specified path.

5. A method according to claim 1, wherein identifying the particular vector comprises identifying the particular vector to be the most similar of the first vectors in comparison to the second vector.

6. A method according to claim 1, wherein, in an instance in which a length of an extended segment of the one or more segments exceeds a threshold, defining the first vectors comprises defining the first vector that includes the extended segment that exceeds the threshold to include a plurality of elements that are each representative of the extended segment that exceeds the threshold.

7. A method according to claim 1, wherein defining the first vectors comprises defining a respective first vector to comprise a plurality of elements representative of the directional information associated with the one or more segments of the respective candidate path, and wherein the plurality of elements uniquely represent each point of interest or each direction associated with the one or more segments of the respective candidate path.

8. A method according to claim 1, further comprising:
identifying a point of interest from the textual description;
determining whether map data that includes the origin and the destination fails to represent the point of interest; and
in an instance in which the map data fails to represent the point of interest, updating the map data to include the point of interest.

9. A method according to claim 8, wherein updating the map data to include the point of interest comprises associating the point of interest with a location that is at least partially defined by the textual description from which the point of interest was identified, and wherein the location is represented by the map data.

10. An apparatus configured to select a path to a destination, the apparatus comprising processing circuitry and at least one memory including computer program code instructions, the computer program code instructions configured to, when executed by the processing circuitry, cause the apparatus to:
define first vectors representative of a plurality of respective candidate paths from an origin to the destination, wherein each first vector is at least partially defined by directional information associated with one or more segments of the respective candidate path;
define a second vector representative of a textual description of a specified path from the origin to the destination, wherein the second vector is at least partially defined by directional information associated with one or more segments of the specified path;
identify a particular vector, from among the first vectors, based on a similarity of the particular vector to the second vector; and
select a particular candidate path, from among the plurality of candidate paths, that is represented by the particular vector identified based on the similarity of the particular vector to the second vector.

11. An apparatus according to claim 10, wherein the computer program code instructions are further configured to, when executed by the processing circuitry, cause the apparatus to convert an audio description of the specified path to the textual description.

12. An apparatus according to claim 10, wherein the computer program code instructions are configured to, when executed by the processing circuitry, cause the apparatus to define the second vector by defining the second vector based on one or more points of interest, one or more landmarks, one or more features of a map or one or more directions associated with the one or more segments of the specified path.

13. An apparatus according to claim 10, wherein the computer program code instructions are configured to, when executed by the processing circuitry, cause the apparatus to identify the particular vector by identifying the particular vector to be the most similar of the first vectors in comparison to the second vector.

14. An apparatus according to claim 10, wherein, in an instance in which a length of an extended segment of the one or more segments exceeds a threshold, the computer program code instructions are configured to, when executed by the processing circuitry, cause the apparatus to define the first vector that includes the extended segment that exceeds the threshold to include a plurality of elements that are each representative of the extended segment that exceeds the threshold.

15. An apparatus according to claim 10, wherein the computer program code instructions are configured to, when executed by the processing circuitry, cause the apparatus to define a respective first vector to comprise a plurality of elements representative of the directional information associated with the one or more segments of the respective candidate path, and wherein the plurality of elements uniquely represent each point of interest or each direction associated with the one or more segments of the respective candidate path.

16. An apparatus according to claim 10, wherein the computer program code instructions are further configured to, when executed by the processing circuitry, cause the apparatus to:
identify a point of interest from the textual description;
determine whether map data that includes the origin and the destination fails to represent the point of interest; and
in an instance in which the map data fails to represent the point of interest, update the map data to include the point of interest.

17. An apparatus according to claim 16, wherein the computer program code instructions are configured to, when executed by the processing circuitry, cause the apparatus to update the map data to represent the point of interest by associating the point of interest with a location that is at least partially defined by the textual description from which the point of interest was identified, and wherein the location is represented by the map data.

18. A method for selecting a path to a destination, the method comprising:
obtaining a second vector representative of an audio description of a specified path from an origin to the destination, wherein the second vector comprises a plurality of elements representative of one or more points of interest, one or more landmarks, one or more features of a map or one or more directions associated with the one or more segments of the specified path, and wherein the plurality of elements of the second vector are ordered sequentially based upon an ordering of the one or more points of interest, one or more landmarks, one or more features of a map or one or more directions associated with the one or more segments of the specified path;
identifying a particular vector, from among a plurality of first vectors representative of a plurality of respective candidate paths from the origin to the destination, based on a similarity of the particular vector to the second vector; and
selecting a particular candidate path, from among the plurality of candidate paths, that is represented by the particular vector identified based on the similarity of the particular vector to the second vector.

19. A method according to claim 18, further comprising:
converting the audio description of the specified path to a textual description; and
defining the second vector based upon the textual description of the specified path.

20. A method according to claim 18, further comprising:
identifying a point of interest from the audio description;
determining whether map data that includes the origin and the destination fails to represent the point of interest; and
in an instance in which the map data fails to include the point of interest, updating the map data to represent the point of interest.
